(19) United States
(12) Patent Application Publication
(10) Pub. No.: US 2007/0234501 A1
(43) Pub. Date: Oct. 11, 2007

(54) Windshield wiper connecter

(76) Inventors: Wen-Chen Ho, Pa Li Hsiang (TW); Chi-Hung Wang, Pa Li Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,995

(22) Filed: Mar. 29, 2007

(30) Foreign Application Priority Data
Apr. 11, 2006 (TW) 95206080

(51) Int. Cl. B60S 1/40

(52) U.S. Cl. 15/250.32; 15/250.43

(57) ABSTRACT

A windshield wiper connecter comprises a top plate, a pair of clipping pieces, a first fastening portion, and a second fastening portion. The pair of clipping pieces are extended respectively from the top plate, and has a pivotal hooking groove between the pair of clipping pieces; the first fastening portion is extended from the top plate and disposed on one side of the pair of clipping pieces, and has a hooking groove; and the second fastening portion is extended from the top plate and disposed on the other side of the pair of clipping pieces, and has a hooking groove; whereby forming a windshield wiper connecter can be connected to a locking windshield arm with different sizes.

### BACKGROUND OF THE INVENTION

1. Field of the Invention

The present invention relates to a windshield wiper connecter, and more particularly to a windshield wiper connecter can be connected to a locking windshield arm with different sizes.

2. Description of the Prior Art

Reference is made to FIG. 1, which is a perspective view of connecting between a windshield wiper connecter 10a and a windshield wiper arm 30a according to the prior art. The connecter 10a has a first hooking groove 11a and a second hooking groove 12a, and the first hooking groove 11a of the connecter 10a is fastened to a pivotal shaft 21a of a windshield wiper framework 20a so as to assemble the connecter 10a on the windshield wiper framework 20a. The windshield wiper arm 30a has a bolt 31a and the bolt 31a is passed through a through hole 22a of the windshield wiper framework 20a and fastened in the second hooking groove 12a of the connecter 10a so as to assemble the windshield wiper arm 30a in the windshield wiper framework 20a by the connecter 10a.

However, the windshield wiper connecter 10a is only used to the windshield wiper arm 30a with single-size bolts 31a, and only if the connecter 10a is remade to apply to the windshield wiper arm 30a with different-size bolts 31a so as to increase production costs and being unpractical.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a windshield wiper connecter can be connected to a locking windshield arm with different sizes to obtain better suitability, more convenient assembly, and stronger structure strength.

For achieving the primary objective stated above, the windshield wiper connecter comprises a top plate is a streamlined plate housing; a pair of clipping pieces are extended respectively from the top plate, and has a pivotal hooking groove between the pair of clipping pieces; a first fastening portion is extended from the top plate and disposed on one side of the pair of clipping pieces, and has a hooking groove; and a second fastening portion is extended from the top plate and disposed on the other side of the pair of clipping pieces, and has a hooking groove.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a perspective view of connecting between a windshield wiper connecter and a windshield wiper arm according to the prior art;

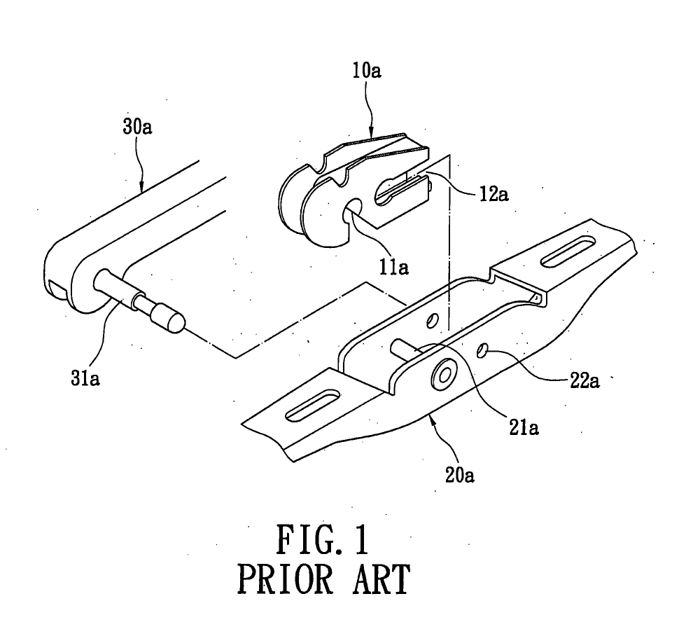

FIG. 2 is a perspective view of a preferred embodiment of a windshield wiper connecter according to the present invention;

FIG. 3 is a cross-sectional view of a preferred embodiment of a windshield wiper connecter according to the present invention; and

FIG. 4 is a perspective view of connecting between a preferred embodiment of a windshield wiper connecter and another windshield wiper arm according to the present invention.

The drawings will be described further in connection with the following detailed description of the present invention.

### DETAILED DESCRIPTION OF THE PREFERRED EMBODIMENTS

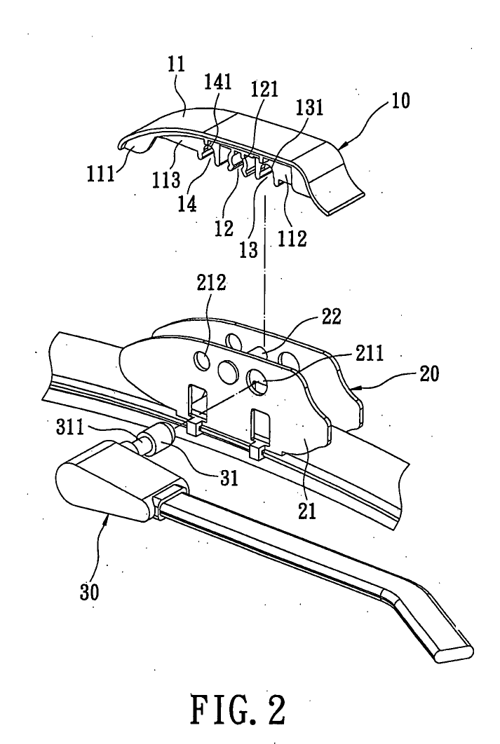

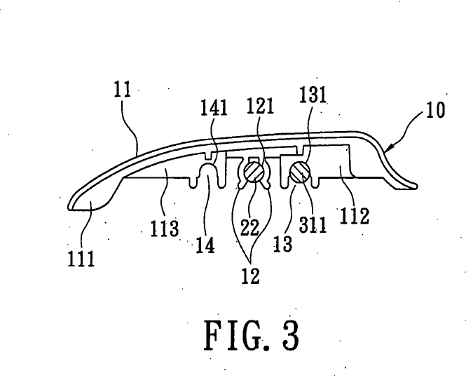

References are made to FIG. 2 and FIG. 3. A windshield wiper connecter 10 of the present invention comprises a top plate 11, a pair of clipping pieces 12, a first fastening portion 13, and a second fastening portion 14.

The top plate 11 is a streamlined plate housing, where the top plate 11 has a protruding pattern or writing sign (not shown) on a surface thereof so as to conveniently assemble a windshield wiper arm 30, and a pair of position-guiding plates 111 are separately extended from a front end and a rear end of the top plate 11 and the pair of position-guiding plates 11 are respectively disposed.

The pair of clipping pieces 12 are downwardly form a middle of the top plate 11 and are respectively disposed, and have a slightly circular-shaped pivotal hooking groove 121 between the pair of clipping pieces 12. Each of the clipping pieces 12 has a free end without connecting with the top plate 11 so that the pivotal hooking groove 121 is elastic.

The first fastening portion 13 is downwardly extended from the top plate 11 and disposed on one side (right side) of the pair of clipping pieces 12, and has a curve-shaped hooking groove 131. The top plate 11 extends a first enhancing rib 112 from right side of the first fastening portion 13 and the first enhancing rib 112 is connected with right side of the first fastening portion 13.

The second fastening portion 14 is downwardly extended from the top plate 11 and disposed on the other side (left side) of the pair of clipping pieces 12, and has a curve-shaped hooking groove 141. The top plate 11 extends a second enhancing rib 113 from left side of the second fastening portion 14 and the second enhancing rib 113 is connected with left side of the second fastening portion 14.

The windshield wiper connecter further has a fixing base 20 and the fixing base 20 has a pair of side plates 21 face to face, and a cylindrical-shaped pivotal shaft 22 is used to connect between an inner surface of the pair of side plates 21 each. Each of the side plates 21 have a first through hole 211 and a second through hole 212, and the first through hole 211 with a larger inside diameter is placed on right side of the pivotal shaft 22 and the second through hole 212 with a smaller inside diameter is placed on left side of the pivotal shaft 22.

A front-end surface and a rear-end surface of the position-guiding plates 111 of the connecter 10 are positioned along inner-side surface of the pair of side plates 21 of the fixing base 20, and next the pivotal hooking groove 121 of the pair of clipping pieces 12 is fastened to the pivotal shaft 22 of the fixing base 20 so as to position and fasten the connecter 10 on the fixing base 20 by the position-guiding plates 111 and the elastic pivotal hooking groove 121.

The windshield wiper arm 30 has a bolt 31 and the bolt 31 has a notch 311, and the bolt 31 is passed through the first through hole 211 of the fixing base 20 to fasten the notch 311 to the hooking groove 131 of the first fastening portion 13 and then connect the windshield wiper arm 30 to the fixing base 20 by the connecter 10.

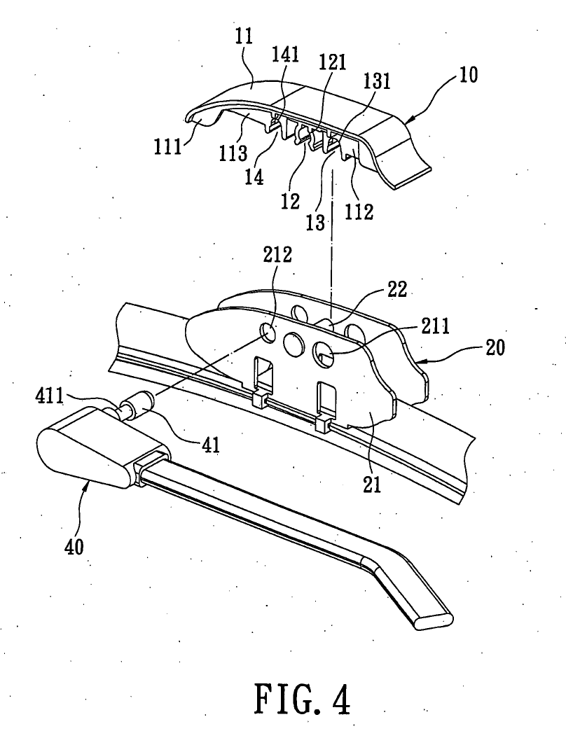

Reference is made to FIG. 4, which is a perspective view of connecting between a preferred embodiment of the windshield wiper connecter 10 and another windshield wiper arm 40 with a bolt 41 of different sizes. The windshield wiper arm 40 has a bolt 41 with a smaller outside diameter and the bolt 41 has a notch 411, and the bolt 41 is passed through the second through hole 212 of the fixing base 20 to fasten the notch 411 to the hooking groove 141 of the second fastening portion 14 and then connect the windshield wiper arm 40 to the fixing base 20 by the connecter 10.

It follows from what has been said that the windshield wiper connecter 10 can connect to the windshield wiper arm 30 with the bolt 31 or the windshield wiper arm 40 with the bolt 41. Hence it provides a better suitability to save costs. Furthermore, the windshield wiper connecter 10 can easily be positioned and assembled on the fixing base 20 by the pair of position-guiding plate 111, and the windshield wiper connecter 10 has a first enhancing rib 112 and a second enhancing rib 113 to enhance the structure strength of the windshield wiper connecter 10.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A windshield wiper connecter used for connecting with a locking windshield wiper arm of a car, comprising:
a top plate;
a pair of clipping pieces extended from the top plate respectively, and having a pivotal hooking groove between the pair of clipping pieces;
a first fastening portion extended from the top plate and disposed on one side of the pair of clipping pieces, and having a hooking groove; and
a second fastening portion extended from the top plate and disposed on another side of the pair of clipping pieces, and having a hooking groove.

2. The windshield wiper connecter as claimed in claim 1, wherein the top plate has a protruding sign on a surface thereof.

3. The windshield wiper connecter as claimed in claim 1, wherein the top plate extends a pair of position-guiding plates, and the pair of position-guiding plates are separately disposed on a front end and a rear end of the top plate.

4. The windshield wiper connecter as claimed in claim 1, wherein the top plate extends a first enhancing rib and a second enhancing rib, and the two enhancing ribs are separately connected with one side of the first fastening portion and one side of the second fastening portion.

5. The windshield wiper connecter as claimed in claim 1, wherein each of the clipping pieces has a free end far away from one side of the top plate.
